(19) United States
(12) Patent Application Publication
(10) Pub. No.: US 2006/0289428 A1
(43) Pub. Date: Dec. 28, 2006

(54) Apparatus for decorative caparison for an ice chest or cooler

(76) Inventor: Denise N. Longua, Malvern, PA (US)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(21) Appl. No.: 11/435,164

(22) Filed: May 16, 2006

Related U.S. Application Data
(60) Provisional application No. 60/594,912, filed on May 17, 2005.

(51) Int. Cl. F27B 9/06; F27D 11/00

(52) U.S. Cl. 219/388

(57) ABSTRACT

A decorative caparison engaging a cooler or ice chest. The caparison is devoid of insulating material and provides a changeable decor that can fit different tastes and environments and is removable for care, storage, and cleaning. An upper section of the caparison is adapted to engage the cover of the cooler, the upper section covering the top surface of the cover and a portion of the body of the cooler. A lower section of the caparison is adapted to engage the body of the cooler, the lower section covering substantially all of the visible body of the cooler. The present invention further includes a cooler having fastening elements which engage corresponding fastening elements on at least one of the upper or lower sections of the caparison to releasably engage the caparison. Finally, the present invention still further includes a method of decorating a cooler packed with perishables and cooling medium.

### RELATED APPLICATION

This application claims the benefit of priority to U.S. Provisional Patent Application Ser. No. 60/594,912, filed on May 17, 2005, the contents of which are incorporated in this application by reference.

### TECHNICAL FIELD

The present invention relates generally to a decorative covering apparatus and, more particularly, to a caparison for a cooler (or ice chest) used in food service.

### BACKGROUND OF THE INVENTION

It is known to provide a portable cooler having an insulated body presenting an open interior space in which ice (or another suitable cooling medium) and one or more articles to be cooled are stored. Typically, a hinged cover, also formed of insulating material, is provided on the cooler for closing the interior space in order to maintain the temperature of the articles in the cooler. Handles are usually secured to or formed in the cooler to facilitate transportation of the cooler, and a drain may be fitted in the body to drain water and other liquids from the cooler without opening the cover.

A wide variety of coolers are commercially available and are well-known in the art. An example of a portable cooler disclosed in the patent art includes the cooler taught by Higgins in U.S. Patent No. 5,816,433. Another example is taught by Perianes in U.S. Pat. No. 6,193,097.

In recent years, portable coolers have increased in popularity, particularly as their portability has been enhanced. Coolers are used at various outings, of course, including picnics, parties, and the like to maintain food and beverages at a desired temperature, usually, but not always, below the temperature of the ambient. To enhance the versatility of such coolers, many are made with wheels and a handle for pulling the cooler on the wheels such as the cooler taught by Conrado et al. in U.S. Pat. No. 6,176,499 (incorporated into this document by reference).

Technical advances in the art of portable coolers have focused on the portability of the cooler and on improvements to the period during which low temperatures are maintained inside the cooler. With respect to improvements directed to temperature maintenance, an example is provided by Jensen et al. in U.S. Pat. No. 5,351,494. Jensen et al. teach a cooler chest insulating blanket which is placed over the food, beverages, and cooling medium in the cooler.

Food and beverages are often provided at events such as weddings, funerals, parties and gatherings that include entertainment, and other social functions. Conventional coolers work very well at these functions for the purpose of chilling and storing food and beverages, while providing easy access to such items. Unfortunately, however, conventional coolers are very unappealing in a formal setting from an aesthetic vantage. Caterers, hosts, and hostesses have been forced to use alternative methods, shunning coolers, that are less efficient in order to avoid the use of unsightly coolers.

To overcome the shortcomings of conventional coolers, a new apparatus is provided. An object of the present invention is to provide an improved apparatus that achieves the functions of a cooler while providing an aesthetically attractive appearance. A related object is not to interfere with the functions of the cooler.

Another object is to provide a decorative caparison that can be applied to and removed from a cooler for care, storage, and cleaning, then reused. It is a further object of the present invention to make the caparison from a material that is washable and is preferably water and stain resistant and fire retardant. An additional object is to use a bulk material for the caparison.

Yet another object of the invention is to avoid complex, sophisticated, and expensive construction in accomplishing the objects. It is the purpose of the present invention to provide the benefits identified above in a dependable, minimally complex, and relatively inexpensive way. Finally, an object of the invention is to provide improved components and arrangements of those components in an apparatus for the purposes described.

### BRIEF SUMMARY OF THE INVENTION

To achieve these and other objects, and in view of its purposes, the present invention provides an apparatus combining a cooler with a decorative caparison. The cooler has (a) an insulated body defining an interior cavity and including a floor, side walls, a front wall, and a rear wall, the interior cavity adapted to store perishables and a cooling medium, (b) a cover including a top surface and being removably positioned on the body to seal the cavity when the cover is in a closed position and to allow access to the cavity when the cover is in an open position, and (c) a first fastening element located on the body of the cooler and a second fastening element located on the cover of the cooler. The caparison has (d) a decorative surface rendering the caparison aesthetically attractive, (e) an upper section including a third fastening element that engages the second fastening element to affix the upper section to the cover of the cooler, the upper section covering the top surface of the cover and a portion of the body of the cooler, and (f) a lower section including a fourth fastening element that engages the first fastening element to affix the lower section to the body of the cooler, the lower section covering substantially all of the visible body of the cooler.

The present invention further includes an attractive, decorative caparison that easily attaches to a food storage cooler or ice chest for use in food services. The caparison provides a variably changeable decor that can fit different tastes and environments and is durable and removable for care, storage, and cleaning. The caparison is aesthetically attractive in that a reasonably objective, average adult observing the caparison would characterize the caparison as decorative.

More specifically, the caparison is devoid of insulating material and is designed to engage a cooler. The caparison has a decorative surface rendering the caparison aesthetically attractive. An upper section of the caparison is adapted to engage the cover of the cooler, the upper section covering the top surface of the cover and a portion of the body of the cooler. A lower section of the caparison is adapted to engage the body of the cooler, the lower section covering substantially all of the visible body of the cooler.

Finally, the present invention still further includes a method of decorating a cooler packed with perishables and cooling medium. The method includes a number of steps. Among those steps are one or more of the following, not necessarily in the order listed. First, a sheet of decorative material is cut to form a caparison of dimensions to fit the cooler. Next, the material is folded and sewn, as necessary, into a predetermined shape. Third, fastening elements are attached to the caparison. Fourth, fastening elements are attached to the cooler. Fifth, the caparison is set into position on the cooler. Ultimately, the caparison is pushed into engagement with the cooler so that the caparison completely covers the cooler.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a perspective view of an exemplary embodiment of a portable cooler made according to the present invention;

FIG. 2 is a perspective view of an exemplary embodiment of a decorative caparison adapted for engagement with the portable cooler shown in FIG. 1; and

FIG. 3 is a block diagram of steps of a method of practicing the present invention.

### DETAILED DESCRIPTION OF THE INVENTION

The apparatus of the present invention has two, main components: a cooler 10 and a caparison 50.

A. The Cooler

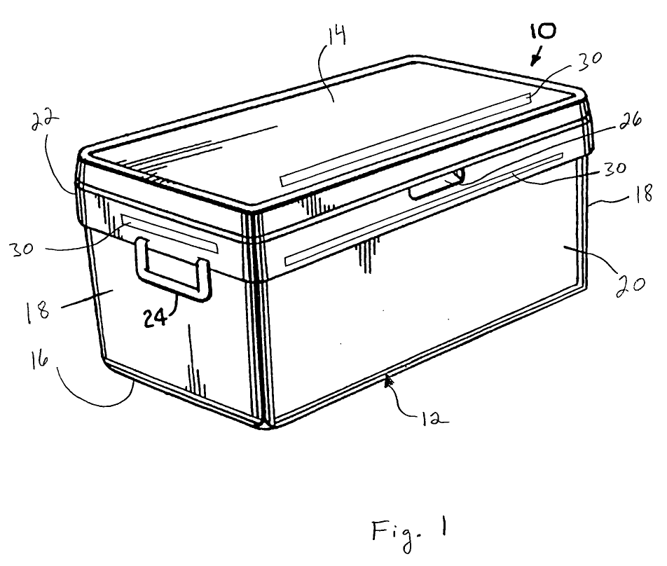

Referring now to the drawing, in which like reference numbers refer to like elements throughout the various figures that comprise the drawing, FIG. 1 shows a first portable cooler 10 (also known as an ice chest) constructed in accordance with the preferred embodiment of the present invention. The cooler 10 is used to store and transport perishables at reduced temperatures. The cooler 10 broadly includes an insulated body 12 and a cover 14 for movement between a closed position in sealing engagement with the body 12 and an open position exposing an interior space or open cavity of the body 12.

The cavity holds both perishables, such as food, and a cold substance for absorbing heat (i.e., a cooling medium). Examples of cooling media include ice and packaged, commercial products intended to go through a freezing and melting cycle during each use. Perishables are variable in nature, having different sizes, shapes, weights, packaging, and other characteristics. The perishables are generally placed in an organized fashion within the cooler 10, and the cooling medium is advantageously placed around the perishables.

To accommodated perishables and cooling media of various sizes and amounts, the cooler 10 can be made in different sizes, shapes, and configurations. Generally, however, the body 12 is rectangular in configuration and includes an upper edge which surrounds the interior cavity. Suitable dimensions for the body 12 are 13 inches (33 cm) in both width and height, and 23.5 inches (60 cm) in length.

The body 12 of the cooler 10 includes a floor 16, two upstanding side walls 18, an upstanding front wall 20, and an upstanding rear wall 22. The body 12 is either formed of an insulating material such as foamed polystyrene or the like, or includes a double-walled construction that insulates the interior cavity of the body 12 from thermal gradients existing across the floor 16, side walls 18, front wall 20, and rear wall 22 that define the cavity. The illustrated embodiment includes a double-walled construction, and is preferably formed of a suitable synthetic resin material such as polypropylene.

The body 12 includes integral handles 24, typically disposed one on each of the side walls 18 of the cooler 10. The user of the cooler 10 can access the handles 24 to lift the cooler 10 as, for example, when loading or unloading the cooler 10 from the trunk of a vehicle. Thus, the handles 24 facilitate transportation of the cooler 10. Although not shown in FIG. 1, each of the side walls 18 may include a grip opening proximate the handles 24 to facilitate access to the handles 24.

A drain (not shown) can be provided in the rear wall 22 or at the bottom of one of the side walls 18 to permit draining of the interior cavity. Desirably, the body 12 also includes a removable drain plug (not shown). The drain plug seals the drain and closes the cavity when drainage is unnecessary.

The top cover 14 of the cooler 10 may or may not be insulated. In a preferred embodiment, like the body 12, the cover 14 is also of double-walled insulating construction. The cover 14 presents an inner surface that mates with the side walls 18, front wall 20, and rear wall 22 of the body 12 to seal the interior cavity of the body 12 shut when the cover 14 is placed in the closed position (as shown in FIG. 1). The cover 14 is connected to the body 12 by a pair of hinges (not shown) that permit opening and closing of the cover 14, but could also be freely removable from the body 12, if desired. If provided, the hinges typically connect the cover 14 to the body 12 at the top of the rear wall 22 and pivot the cover 14 about a common pivot axis.

The cover 14 is sized and shaped to fit over and seal the body 12. If desired, a seal and groove combination may be disposed about the exterior of the cover 14 to create a sealing engagement with the upper edge of the body 12. Thus, the cover 14 is typically rectangular if the body is rectangular. Suitable dimensions for the cover 14 are 13 inches (33 cm) in width, 23.5 inches (60 cm) in length, and 2 inches (5 cm) in height. As illustrated in FIG. 1, the cover 14 has a flat upper surface which may be used as a table surface.

The body 12 includes a small hand grip recess 26 located near the top of the front wall 20 just underneath the cover 14 when the cover 14 is sealed on the body 12. The recess 26 is located to allow the user to easily grasp the cover 14 by its edge for opening purposes. Specifically, the user of the cooler 10 can insert their fingers into the recess 26 to lift the cover 14 off the cooler 10, for example, when seeking access to the items located in the cavity of the cooler 10. Alternatively, the recess 26 could be located in the front edge of the cover 14.

In a preferred embodiment of the present invention, at least one—and preferably both—of the body 12 and the cover 14 of the cooler 10 has—or have—an element helpful in securing the caparison 50 to the cooler 10. In the exemplary embodiment shown in FIG. 1, a Velcro® brand fabric hook-and-loop tape 30 is affixed near the tops of the side walls 18, front wall 20, and rear wall 22 of the body 12 and on the top surface near the front edge of the cover 14. Hook-and-loop fasteners consist of two layers: a hard “hook” layer, which is a piece of fabric covered with tiny plastic hooks, and a soft or fuzzy “loop” layer, which is covered with even smaller and “hairier” plastic loops. There are many variations to this configuration some of which, for example, include hooks on both layers. When the two layers are pressed together, the hooks catch in the loops and hold the objects together. When the layers are separated, they make a characteristic ripping sound.

The term Velcro® is a registered trademark in most countries, identifying a product offered by Velcro Industries and used for connecting objects. Generic terminology for these fasteners includes “hook-and-loop,” “burr,” and “touch” fasteners. Hook-and-loop tape 30 is available in various materials (e.g., nylon, polyester), some fire retardant, and in various sizes (e.g., up to 6 inches or 15 cm wide). Tape 30 having a width of 1 inch (2.5 cm) is suitable. Tape 30 may be provided with a wide variety of adhesives, depending on the substrate (such as the cooler 10) to which the tape 30 will stick, the strength needed, and the environments to which it will be exposed. Tape 30 also may be sewn onto the substrate (such as the caparison 50).

B. The Caparison

In addition to the cooler 10, the second main component of the present invention is an ornamental covering: the decorative caparison 50. The caparison 50 easily attaches to and can be removed from the cooler 10. The caparison 50 is constructed of a fitted material designed to completely cover the visible surfaces of the cooler 10. Thus, the caparison 50 provides a variably changeable decor that can fit different aesthetic tastes and environments.

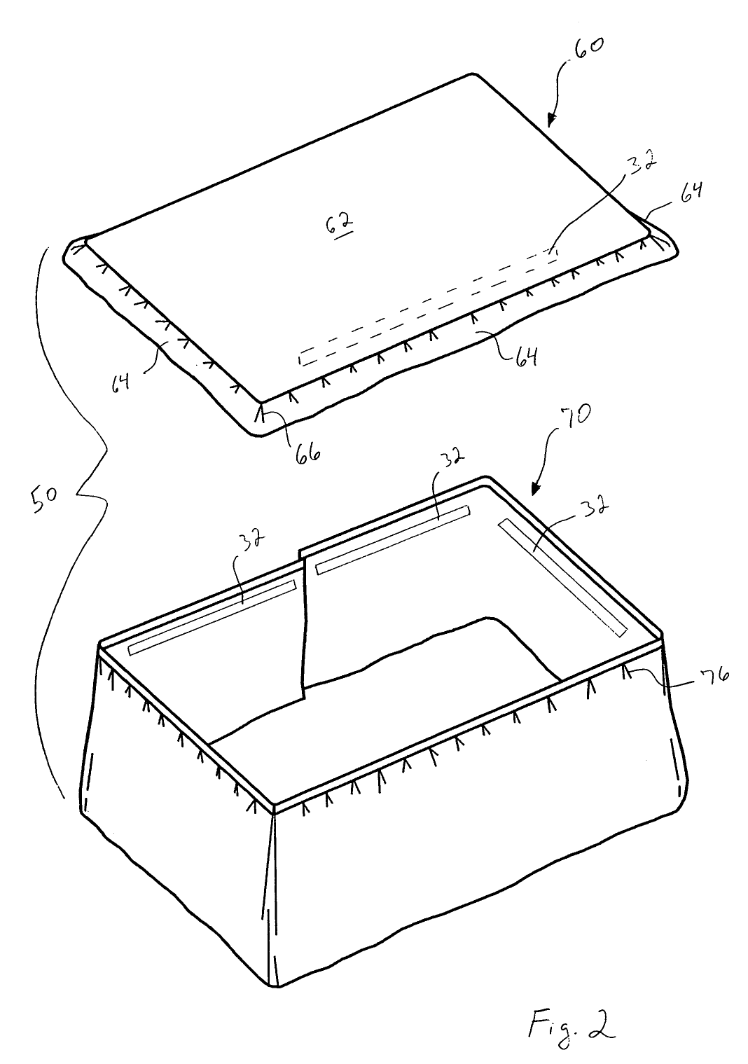

The caparison 50 includes two pieces, an upper section 60 and a lower section 70. The upper section 60 attaches to the cover 14 of the cooler 10. The lower section 70 attaches to the body 12 of the cooler 10. The caparison 50 can be made in various sizes and shapes to accommodate the corresponding size and shape of the cooler 10 to which the caparison 50 will be engaged. As illustrated in FIG. 2, the lower section 70 of the caparison 10 may be wrapped around the body 12, so that one size of lower section 70 will fit coolers having a number of different-sized bodies.

The upper section 60 of the caparison 50 has a top panel 62 (which engages the top surface of the cover 14) and four side panels 64 (which hang down over the cover 14 and cover the tops of side walls 18, front wall 20, and rear wall 22). The top panel 62 and side panels 64 may be formed in one piece or sewn together. The lower section 70 of the caparison 50 is preferably a single panel of material, but also might be formed from multiple panels sewn together. Pleats 66, 76 or other decorative forms may be provided on one or both of the upper section 60 or the lower section 70 of the caparison 50. Color, material, and other design choices will vary per marketing directives and aesthetic desires.

Like the cooler 10, the caparison 50 has an element helpful in securing the caparison 50 to the cooler 10. A variety of elements could perform that function, and such elements are well-known to the artisan. For purposes of example only, and without limitation, the elements include hook-and-loop fasteners, glue, staples or other like fasteners, adhesive tape (which may have adhesive on both of its sides), and male-female snap combinations. The hook-and-loop fasteners provided by the tape 32 are illustrated in the drawing. Like corresponding tape 30, tape 32 may have a width of 1 inch (2.5 cm).

As illustrated in FIG. 2, several strips of tape 32 are affixed (e.g., sewn or through adhesive) to the inside of the lower section 70 of the caparison 10. Alternatively, the tape 32 might encircle the entire inside perimeter of the lower section 70. The tape 32 provides the lower section 70 with several anchor points that affix to the corresponding tape 30 positioned around the outer perimeter of the body 12 of the cooler 10. When tape 32 is affixed to tape 30, the lower section 70 of the caparison 10 hangs downward and covers the body 12 of the cooler 10.

Similarly, as illustrated in FIG. 2, at least one strip of tape 32 is affixed (e.g., sewn or through adhesive) to the inside of the upper section 60 of the caparison 10. Alternatively, the tape 32 might encircle the entire inside perimeter of the upper section 60. The tape 32 provides the upper section 60 with several anchor points that affix to the corresponding tape 30 positioned on the cover 14 of the cooler 10. When tape 32 is affixed to tape 30, the upper section 60 of the caparison 10 engages the upper surface of the cover 14 and hangs downward over a top portion of the body 12 of the cooler 10.

A problem that arises in the use of the cooler 10 is that of repeated opening and closing of the cover 14 each time a food or beverage article is retrieved from the cooler 10. To address that problem, the front edge of the tape 32 affixed to the upper section 60 of the caparison 50 is located (as shown in FIG. 2) proximate (i.e., about 1-3 inches or 2.5-7.5 cm from) the front edge of the upper section 60 (and, therefore, of the cover 14 when the upper section 60 engages the cover 14). This location permits the user to open and close the cover 14 (especially a hinged cover 14, which pivots between the open and closed positions) without having the upper section 60 of the caparison 50 fall way from and expose the cover 14.

The caparison 50 is made from flexible natural or synthetic material. The material used to construct the caparison 50 is durable so that the caparison 50 can be removed from the cooler 10 for care, storage, and cleaning, then reused. The material should be washable and is preferably water and stain resistant and fire retardant.

Thus, the invention includes a caparison 50 made from a flexible sheet of a sturdy, readily available material, which is advantageously arranged over the cooler 10 so as to render the cooler 10 aesthetically attractive. The material is preferably a bulk material such as cloth. This material is readily cut or otherwise trimmed to desired dimensions, is easily folded, and could be washed. It is therefore very practical for the typical consumer. So that the material is as inexpensive as possible and, at least in some cases, disposable after a single use or after it becomes soiled, the material expressly does not have good insulating characteristics. Rather, the material is decorative only and offers no other function. The material can be purchased in bulk lots, cut and sewn as desired, and placed on the cooler 10.

Because the material contemplated for caparison 50 is sold in bulk, as in rolls, it is unlikely that a sheet cut from a roll will fit the cooler 10 precisely. Therefore, the material may be trimmed or cut to an appropriate, predetermined size and configuration corresponding to the dimensions of the cooler 10. The term “predetermined” means that the size and configuration are determined (i.e., chosen or at least known) beforehand in advance of the trim or cut operation. Both the lower section 70 and the side panels 64 of the upper section 60 hang such that, together, they cover the entire visible area of the cooler 10. The upper section 60 and lower section 70 are sized and shaped so that they fit the cooler 10 precisely, if loosely, and leave neither gaps nor humps.

It is also possible to make the caparison 50 from a material suitable to allow the caparison to form or stretch fit onto the cooler 10, thereby avoiding the need for separate fastener elements. For example, the lower section 70 of the caparison 50 may be made like a sock which engages the body 12 (as a sock would engage a foot) of the cooler 10. Alternatively or additionally, the upper section 60 of the caparison 50 might be made of a form-fit material while the lower section 70 is attached to the body 12 using separate fastener elements. Another alternative is to permanently affix the upper section 60, the lower section 70, or both sections to the cooler 10. By “permanently affix” is meant that the caparison 50 is not easily removed from and reapplied to the cooler 10.

C. Method of Use

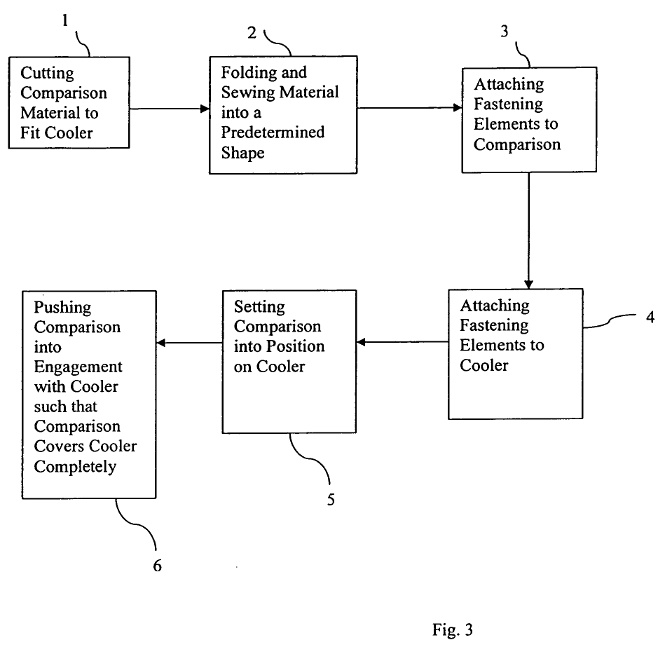

Turning now to FIG. 3, example steps of the method of practicing the invention are illustrated. Included in the method is an optional first step of cutting a sheet of material, as from a bulk roll, to form the lower section 60 and the upper section 70 of the caparison 50. The material is cut to correspond to the dimensions of the cooler 10, and may be oversized somewhat so that portions of the lower section 60, the upper section 70, or both may overlap. An optional step two is the folding, sewing, or both folding and sewing of the material into a predetermined shape. An optional step three is to attach elements helpful in securing the caparison 50 to the cooler 10 to the material. An optional step four is to attach elements helpful in securing the caparison 50 to the cooler 10 to the cooler 10. Main steps of the method are setting the lower section 60 and the upper section 70 of the caparison 50 into position on the cooler 10, and pushing the caparison sections 60, 70 into engagement with the cooler 10 so that the caparison 50 completely covers the cooler 10.

During use of the cooler 10, the top cover 14 is opened and the interior cavity of the body 12 is filled with ice, water, or any other suitable cooling medium. In addition, food and beverage items may be placed in the cavity. The caparison 50 is placed into engagement with the cooler 10 either before or after the cooler 10 is loaded with cooling medium and food and beverage items. Thereafter, the cover 14 is closed and need not be reopened unless it is necessary to retrieve one of the items placed in the interior cavity with the cooling medium.

While retaining the desired temperature of the food and beverage items, the cooler 10 with the caparison 50 in place provides a decorative apparatus suitable for display at even formal functions like weddings. In addition, as noted above, the cover 14 of the cooler 10 is often used as a table. If so, the cover 14 with the upper section 60 of the caparison 50 in place provides the advantages of a table having a decorative tablecloth.

Although illustrated and described above with reference to certain specific embodiments, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

With respect to the above description then, it is to be realized that the optimum dimensional relationships for the parts of the invention, to include variations in size, materials, shape, form, function and manner of operation, assembly and use, are deemed readily apparent to one skilled in the art, and all equivalent relationships to those described in the specification are intended to be encompassed by the present invention. Therefore, the foregoing is considered as illustrative only of the principles of the invention. Further, because numerous modifications and changes will readily occur to those skilled in the art, it is not desired to limit the invention to the exact construction and operation shown and described and, accordingly, all suitable modifications and equivalents fall within the scope of the invention.

What is claimed:

1. An apparatus comprising:
a cooler having:
(a) an insulated body defining an interior cavity and including a floor, side walls, a front wall, and a rear wall, the interior cavity adapted to store perishables and a cooling medium,
(b) a cover including a top surface and being removably positioned on the body to seal the cavity when the cover is in a closed position and to allow access to the cavity when the cover is in an open position, and
(c) a first fastening element located on the body of the cooler and a second fastening element located on the cover of the cooler; and
a caparison having:
(d) a decorative surface rendering the caparison aesthetically attractive,
(e) an upper section including a third fastening element that engages the second fastening element to affix the upper section to the cover of the cooler, the upper section covering the top surface of the cover and a portion of the body of the cooler, and
(f) a lower section including a fourth fastening element that engages the first fastening element to affix the lower section to the body of the cooler, the lower section covering substantially all of the visible body of the cooler.

2. The apparatus according to claim 1 wherein the cover of the cooler is insulated.

3. The apparatus according to claim 1 wherein the body of the cooler further has handles.

4. The apparatus according to claim 1 further comprising hinges attaching the cover to the body and wherein the cover pivots between its open and closed positions.

5. The apparatus according to claim 1 further comprising a recess located on one of the body or the cover to facilitate grasping of the cover.

6. The apparatus according to claim 1 wherein the first, second, third, and fourth fastening elements are hook-and-loop fasteners.

7. The apparatus according to claim 1 wherein the lower section of the caparison is wrapped around the body of the cooler so that one size of the lower section will fit coolers having a number of different-sized bodies.

8. The apparatus according to claim 1 wherein the upper section of the caparison has a front edge and the third fastening element is located proximate that front edge and wherein the cover of the cooler has a front edge and the second fastening element is located proximate that front edge.

9. The apparatus according to claim 8 wherein the third fastening element is located about 2.5-7.5 cm from the front edge of the upper section of the caparison.

10. The apparatus according to claim 1 wherein the caparison is made of cloth.

11. A caparison devoid of insulating material for engaging a cooler, the cooler having (a) an insulated body defining an interior cavity and including a floor, side walls, a front wall, and a rear wall, the interior cavity adapted to store perishables and a cooling medium, and (b) a cover including a top surface and being removably positioned on the body to seal the cavity when the cover is in a closed position and to allow access to the cavity when the cover is in an open position, the caparison comprising:
(i) a decorative surface rendering the caparison aesthetically attractive;
(ii) an upper section adapted to engage the cover of the cooler, the upper section covering the top surface of the cover and a portion of the body of the cooler; and
(iii) a lower section adapted to engage the body of the cooler, the lower section covering substantially all of the visible body of the cooler.

12. The caparison according to claim 11 wherein the upper section has a fastening element that affixes the upper section to the cover of the cooler.

13. The caparison according to claim 12 wherein the lower section has a fastening element that affixes the lower section to the body of the cooler.

14. The caparison according to claim 13 wherein the fastening elements are hook-and-loop fasteners.

15. The apparatus according to claim 12 wherein the upper section of the caparison has a front edge and its fastening element is located proximate that front edge.

16. The caparison according to claim 11 wherein the lower section is adapted to wrap around the body of the cooler so that one size of the lower section will fit coolers having a number of different-sized bodies.

17. The caparison according to claim 11 wherein the upper section is adapted to engage the cover of the cooler via a form or stretch material fit.

18. The caparison according to claim 11 wherein the lower section is adapted to engage the body of the cooler via a form or stretch material fit.

19. The caparison according to claim 11 wherein the caparison is made of cloth.

20. A method of decorating a cooler packed with perishables and cooling medium, comprising the steps of:
(a) cutting a sheet of decorative material to from a caparison of dimensions to fit the cooler;
(b) folding and sewing the material into a predetermined shape;
(c) attaching fastening elements to the caparison;
(d) attaching fastening elements to the cooler;
(e) setting the caparison into position on the cooler; and
(f) pushing the caparison into engagement with the cooler so that the caparison completely covers the cooler.
